(19) United States
(12) Patent Application Publication
(10) Pub. No.: US 2022/0068150 A1
(43) Pub. Date: Mar. 3, 2022

(54) ORGANIZATION SYSTEM, ORGANIZATION PROCESS, LEARNING SYSTEM, MEMORIZATION PROCESS, CONCEPT INCORPORATION SYSTEM, CONCEPT INCORPORATION PROCESS, AND METHODS OF USE FOR UNDERSTANDING GENERAL KNOWLEDGE OF IMPORTANT AND DIFFICULT INFORMATION

(71) Applicant: Jennifer Zahourek, Concord, CA (US)

(72) Inventor: Jennifer Zahourek, Concord, CA (US)

(21) Appl. No.: 17/460,418

(22) Filed: Aug. 30, 2021

Related U.S. Application Data
(60) Provisional application No. 63/072,279, filed on Aug. 31, 2020.

(51) Int. Cl. G09B 5/06; G06Q 10/10; G06Q 40/02; G06Q 50/20

(52) U.S. Cl. CPC G09B 5/065; G06Q 50/205; G06Q 40/02; G06Q 10/1097

(57) ABSTRACT

An organization system, organization process, learning system, memorization process, concept incorporation system, concept incorporation process, processes, and method of use are presented. More specifically and without limitation, this disclosure relates to a durable and beautiful program and system that will make a user knowledgeable and organized. More specifically and without limitation, this disclosure relates to training medical practitioners such as nurses in the field of nursing. More specifically and without limitation, this disclosure relates to training nursing professionals. More specifically, and without limitation, this disclosure relates to life planning. More specifically, and without limitation, this disclosure relates to providing activities, questions, reference guides, and other activities in a system which provides a unique and systematic manner of remembering difficult concepts and information.

### CROSS-REFERENCE TO RELATED APPLICATIONS

The present application claims priority to the U.S. Provisional Patent Application No. 63/072,279 which was filed on Aug. 31, 2020, which is hereby incorporated by reference herein in its entirety, including any figures, tables, or drawings.

### FIELD OF THE DISCLOSURE

This disclosure relates to a medical specialty organization system, organization process, learning system, memorization process, concept incorporation system, concept incorporation process, and methods of use for understanding general knowledge of important and difficult information. More specifically and without limitation, this disclosure relates to a durable and handcrafted tool that will make a user knowledgeable and organized. More specifically and without limitation, this disclosure relates to training medical practitioners such as nurses in the field of nursing. More specifically and without limitation, this disclosure relates to training nursing professionals. More specifically, and without limitation, this disclosure relates to life planning. More specifically, and without limitation, this disclosure relates to providing activities, questions, reference guides, and other activities in a system which provides a unique and systematic manner of remembering difficult concepts and information.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright RekMed, LLC. All rights reserved.

### BACKGROUND OF THE DISCLOSURE

A common issue with high level practice, in any field, is knowledge, exposure and overall the readily available knowledge necessary for various tasks. Exposure to everyday practice of any profession creates a gap between the novice and the expert. Novices can only become experts through experience, but this experience can be intimidating and difficult at best, and often can be associated with a painful learning process. Additionally, remembering and developing skills can often only be remembered once put into practice. In the medical field, this can potentially mean a lower quality of care for a patient.

One particular field where knowledge, understanding, and skill are necessary to improve one's skills in the art is the medical field. Medical professionals are subjected to complex tasks involving an overlapping of a variety of complex human systems. Combine these systems with historical patient data, environmental effects, and more, and it quickly becomes apparent how complex any single task can be for a medical professional. Inexperienced medical professionals or learning medical professionals may have difficulty digesting all this information while also learning. Even experienced practitioners are often victims of their own subjective analysis.

To complicate matters further, a medical professional, such as a nurse, must go through a difficult medical school, through advanced education. Advanced education, and especially nurse training is very difficult. The field is both mentally and physically demanding. Nursing school is generally designed to simulate both the mental and physical demands of the field. For this reason, organization in lifestyle is key. Furthermore, organization of the training and assimilation of knowledge, large amounts of knowledge and information, is also key to success in life as a nurse and in training as a nursing student.

To complicate matters further, due to the complexity of tasks associated with the medical profession, it has been impossible to develop an objective means to measure the success of such tasks. Many tasks are determined to be successful if they help a patient feel better or improve upon the lives of a patient. Micro-data or large scale objective data is almost impossible to come by. Furthermore, large scale ratings or ratings for success of a student in harnessing these skills is impossible to measure. As such, measuring the knowledge gained in school can be difficult and confidence of an individual at various tasks can be difficult.

Current academic training methods for the medical profession, and particularly for the art of training medical professionals and training medical professionals in work life balance are very difficult for students to learn and may be even more difficult to teach, if taught at all. Furthermore, evaluating how well a student has learned this art may be inaccurate which results in a poor evaluation of the students abilities. Having a true measure of one's abilities is critical to awarding a student for their accomplishments. Thus, a means of improving teaching, evaluation, and diagnosing is severely needed in the art of both teaching and practicing.

So, while there are teaching methods currently being used in the art which consist of in class instruction, video instruction, and textbook study, these common methods may not be considered real world. Furthermore, these learning methods do not provide a medical professional with what the actual practice of medicine will look like, when intertwined with a work, life balance. Additionally, these teachings are standalone and do not offer regular supplements for a sustained exposure of knowledge much like an intravenous drip over a period of time.

Complicating matters further, there are no tools available for a nurse to develop a work life balance and quickly and easily organize complex medical tasks, school tasks, and the like. The medical profession, nursing in particular, includes complex tasks that include many variables and factors which are school dependent on success and go beyond school, such as work life balance.

Textbooks are not able to simulate a variety of these various factors in a simulation. Thus, learning the diagnostic process in the medical profession is extremely difficult for students and teachers in a classroom setting. For this reason, it usually takes practice, sometimes years of practice, to harness the skill of work life balance. This involves memorization and continued practice, quick guides, references, and complex workflow not easily organized, let alone organized and integrated into a work life balance. Complicating matters further, less often do nursing students receive feedback, have any feedback on work life balance, or does any student have feedback on progress or how to manage work life balance. Sometimes a student only has the feedback of instructors on progress in a particular field. In some cases, it may be that a student never fully develops the means to be organized and balance work and life, even as an experienced professional. Furthermore, some tasks may fade from memory after durations of non use or non practice.

Thus, it is a primary object of this disclosure to provide an organization system, organization process, learning system, memorization process, concept incorporation system, concept incorporation process, and methods of use for understanding general knowledge of important and difficult information. In this way, the an organization system, organization process, learning system, memorization process, concept incorporation system, concept incorporation process, and methods of use for understanding general knowledge of important and difficult information provides a student with a way to organize, assimilate, and balance life as a student, as a professional, as a practitioner, and integrate these roles into their personal life. In this way, a student or practitioner can learn through a fun environment and/or system which rewards for learning and creates repetition to master skills while providing feedback from easy to access and understand resources. In this way, progress can be made, objectives learned, concepts retained, and balance created.

The disclosure herein provides these advantages and others as will become clear from the specification and claims provided.

### SUMMARY OF THE DISCLOSURE

An organization system, organization process, learning system, memorization process, concept incorporation system, concept incorporation process, and methods of use for understanding general knowledge of important and difficult information through interaction and ongoing interactions. In this way, the present disclosure provides an interactive learning environment that allows students to learn medical skills while balancing work and life. More specifically, the disclosure provides an organization system, organization process, learning system, memorization process, concept incorporation system, concept incorporation process, and methods of use for understanding general knowledge of important and difficult information.

In many circumstances, it takes years to harness and gain experience in the medical field, especially in the field of nursing. In traditional practice the years provide continued exposure which provides expertise. In the disclosure herein, continued exposure is provided over a duration of time. The simulations provided through the complex disclosure and advancements in technology and systems developed as part of this disclosure provides for harnessing these various skills associated with managing life as a student, associated with later patient care and perfecting the art of work life balance while providing an objective learning tool for use by teachers, students, and professionals.

Thus, the disclosure utilizes a plurality of tools from organizational tools, to guides, to quick references, to quizzing, to hierarchies to create environments, learning scenarios, and life scenarios that provide an easy way of organizing and learning.

Thus, it is a primary object of the disclosure to provide an organization system, organization process, learning system, memorization process, concept incorporation system, concept incorporation process, and methods of use for understanding general knowledge of important and difficult information.

Another object of the disclosure is to provide an organization system, organization process, learning system, memorization process, concept incorporation system, concept incorporation process, and methods of use for understanding general knowledge of important and difficult information that introduces core concepts of nursing.

Yet another object of the disclosure is to provide an organization system, organization process, learning system, memorization process, concept incorporation system, concept incorporation process, and methods of use for understanding general knowledge of important and difficult information that introduces core concepts of nursing and puts them into basic activities.

Another object of the disclosure is to provide an organization system, organization process, learning system, memorization process, concept incorporation system, concept incorporation process, and methods of use for understanding general knowledge of important and difficult information that helps a user and/or users understand general knowledge of important and difficult to understand information and/or concepts.

Yet another object of the disclosure is to provide an organization system, organization process, learning system, memorization process, concept incorporation system, concept incorporation process, and methods of use for understanding general knowledge of important and difficult information that is a durable tool for users.

Another object of the disclosure is to provide an organization system, organization process, learning system, memorization process, concept incorporation system, concept incorporation process, and methods of use for understanding general knowledge of important and difficult information that is handcrafted and provides personal touches.

Yet another object of the disclosure is to provide an organization system, organization process, learning system, memorization process, concept incorporation system, concept incorporation process, and methods of use for understanding general knowledge of important and difficult information that provides for life planning.

Another object of the disclosure is to provide an organization system, organization process, learning system, memorization process, concept incorporation system, concept incorporation process, and methods of use for understanding general knowledge of important and difficult information that provides relevant activities for a user.

Yet another object of the disclosure is to provide an organization system, organization process, learning system, memorization process, concept incorporation system, concept incorporation process, and methods of use for understanding general knowledge of important and difficult information that provides relevant and regular questions for a user to answer, and also provides an easy to understand answer and/or feedback.

Another object of the disclosure is to provide an organization system, organization process, learning system, memorization process, concept incorporation system, concept incorporation process, and methods of use for understanding general knowledge of important and difficult information that provides reference guides.

Yet another object of the disclosure is to provide an organization system, organization process, learning system, memorization process, concept incorporation system, concept incorporation process, and methods of use for understanding general knowledge of important and difficult information that provides friendly feedback and stickers.

Another object of the disclosure is to provide an organization system, organization process, learning system, memorization process, concept incorporation system, concept incorporation process, and methods of use for understanding general knowledge of important and difficult information that provides drills for understanding difficult concepts.

Yet another object of the disclosure is to provide an organization system, organization process, learning system, memorization process, concept incorporation system, concept incorporation process, and methods of use for understanding general knowledge of important and difficult information that provides references for quick answers.

Another object of the disclosure is to provide an organization system, organization process, learning system, memorization process, concept incorporation system, concept incorporation process, and methods of use for understanding general knowledge of important and difficult information that provides for yearly based planning.

Yet another object of the disclosure is to provide an organization system, organization process, learning system, memorization process, concept incorporation system, concept incorporation process, and methods of use for understanding general knowledge of important and difficult information that provides for monthly based planning.

Another object of the disclosure is to provide an organization system, organization process, learning system, memorization process, concept incorporation system, concept incorporation process, and methods of use for understanding general knowledge of important and difficult information that provides for daily planning.

Yet another object of the disclosure is to provide an organization system, organization process, learning system, memorization process, concept incorporation system, concept incorporation process, and methods of use for understanding general knowledge of important and difficult information that provides for budget planning.

Another object of the disclosure is to provide an organization system, organization process, learning system, memorization process, concept incorporation system, concept incorporation process, and methods of use for understanding general knowledge of important and difficult information that provides productive feedback.

Yet another object of the disclosure is to provide an organization system, organization process, learning system, memorization process, concept incorporation system, concept incorporation process, and methods of use for understanding general knowledge of important and difficult information that provides inspiration.

Another object of the disclosure is to provide an organization system, organization process, learning system, memorization process, concept incorporation system, concept incorporation process, and methods of use for understanding general knowledge of important and difficult information that provides list making.

Yet another object of the disclosure is to provide an organization system, organization process, learning system, memorization process, concept incorporation system, concept incorporation process, and methods of use for understanding general knowledge of important and difficult information that provides for password saving and organization.

Another object of the disclosure is to provide an organization system, organization process, learning system, memorization process, concept incorporation system, concept incorporation process, and methods of use for understanding general knowledge of important and difficult information that provides for connection logs.

Yet another object of the disclosure is to provide an organization system, organization process, learning system, memorization process, concept incorporation system, concept incorporation process, and methods of use for understanding general knowledge of important and difficult information that provides for grade tracking.

Another object of the disclosure is to provide an organization system, organization process, learning system, memorization process, concept incorporation system, concept incorporation process, and methods of use for understanding general knowledge of important and difficult information that provides for a plurality of tabs.

Yet another object of the disclosure is to provide an organization system, organization process, learning system, memorization process, concept incorporation system, concept incorporation process, and methods of use for understanding general knowledge of important and difficult information that provides for medical evaluation simulation.

Another object of the disclosure is to provide an organization system, organization process, learning system, memorization process, concept incorporation system, concept incorporation process, and methods of use for understanding general knowledge of important and difficult information that provides medical evaluation simulation and various treatment and diagnosis explanations.

Yet another object of the disclosure is to provide an organization system, organization process, learning system, memorization process, concept incorporation system, concept incorporation process, and methods of use for understanding general knowledge of important and difficult information that provides for note taking.

Another object of the disclosure is to provide an organization system, organization process, learning system, memorization process, concept incorporation system, concept incorporation process, and methods of use for understanding general knowledge of important and difficult information that provides a plurality of tools for nursing school.

Yet another object of the disclosure is to provide an organization system, organization process, learning system, memorization process, concept incorporation system, concept incorporation process, and methods of use for understanding general knowledge of important and difficult information that provides a plurality of tools and systems for work life balance planning and organizing.

Another object of the disclosure is to provide an organization system, organization process, learning system, memorization process, concept incorporation system, concept incorporation process, and methods of use for understanding general knowledge of important and difficult information that provides for development of professional nursing skills.

Yet another object of the disclosure is to provide an organization system, organization process, learning system, memorization process, concept incorporation system, concept incorporation process, and methods of use for understanding general knowledge of important and difficult information that is capable of computing tasks based on timing and organization.

Another object of the disclosure is to provide an organization system, organization process, learning system, memorization process, concept incorporation system, concept incorporation process, and methods of use for understanding general knowledge of important and difficult information that is capable of computing feedback.

Yet another object of the disclosure is to provide an organization system, organization process, learning system, memorization process, concept incorporation system, concept incorporation process, and methods of use for understanding general knowledge of important and difficult information that provides feedback and real time analysis.

Another object of the disclosure is to provide an organization system, organization process, learning system, memorization process, concept incorporation system, concept incorporation process, and methods of use for understanding general knowledge of important and difficult information that provides information displays.

Yet another object of the disclosure is to provide an organization system, organization process, learning system, memorization process, concept incorporation system, concept incorporation process, and methods of use for understanding general knowledge of important and difficult information that provides a feedback board.

Another object of the disclosure is to provide an organization system, organization process, learning system, memorization process, concept incorporation system, concept incorporation process, and methods of use for understanding general knowledge of important and difficult information that provides encouragement boards for interaction of cohorts.

Yet another object of the disclosure is to provide an organization system, organization process, learning system, memorization process, concept incorporation system, concept incorporation process, and methods of use for understanding general knowledge of important and difficult information that provides a database of shared experiences.

Another object of the disclosure is to provide an organization system, organization process, learning system, memorization process, concept incorporation system, concept incorporation process, and methods of use for understanding general knowledge of important and difficult information that is customizable.

Yet another object of the disclosure is to provide an organization system, organization process, learning system, memorization process, concept incorporation system, concept incorporation process, and methods of use for understanding general knowledge of important and difficult information that can be implemented and/or adopted with relative ease.

Another object of the disclosure is to provide an organization system, organization process, learning system, memorization process, concept incorporation system, concept incorporation process, and methods of use for understanding general knowledge of important and difficult information that incorporates a plurality of application programming interfaces for various functionality.

Yet another object of the disclosure is to provide an organization system, organization process, learning system, memorization process, concept incorporation system, concept incorporation process, and methods of use for understanding general knowledge of important and difficult information that is easy and fun to use.

Another object of the disclosure is to provide an organization system, organization process, learning system, memorization process, concept incorporation system, concept incorporation process, and methods of use for understanding general knowledge of important and difficult information that provides feedback and trends and can display trends to aid in organization and understanding.

Yet another object of the disclosure is to provide an organization system, organization process, learning system, memorization process, concept incorporation system, concept incorporation process, and methods of use for understanding general knowledge of important and difficult information that is user friendly.

Another object of the disclosure is to provide an organization system, organization process, learning system, memorization process, concept incorporation system, concept incorporation process, and methods of use for understanding general knowledge of important and difficult information that is intuitive.

These and other objects, features, or advantages of the present disclosure will become apparent from the specification and claims.

### BRIEF DESCRIPTION OF THE DRAWINGS

FIG. 1 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component.

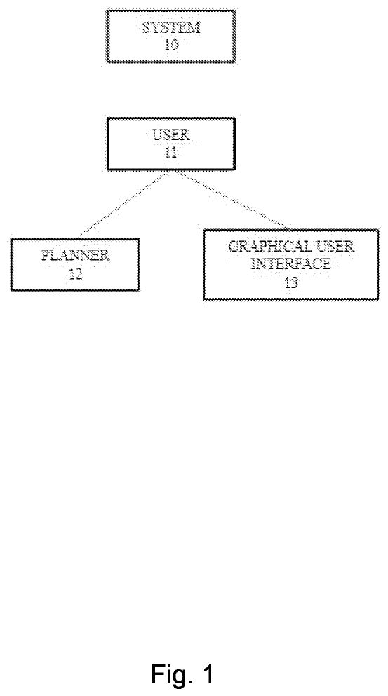

FIG. 2 is a an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing various layouts associated with both hard copy and online interactions.

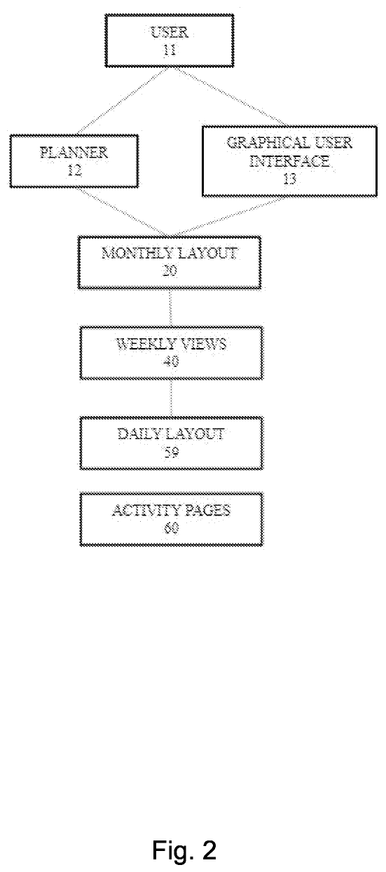

FIG. 3 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing various pages and items tracked.

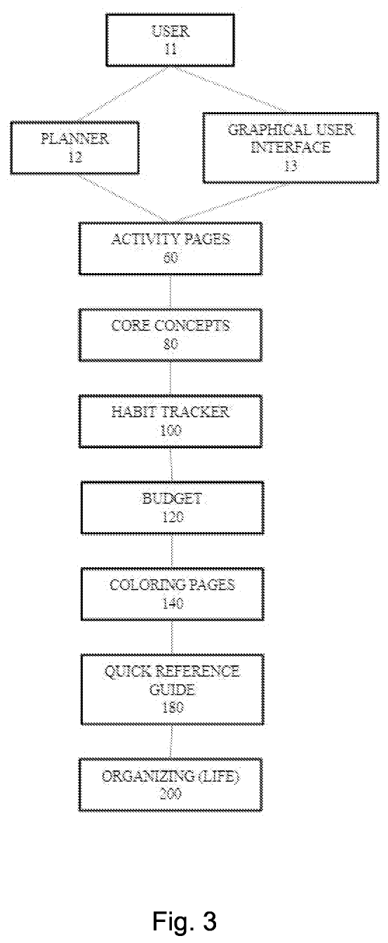

FIG. 4 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing various interaction features.

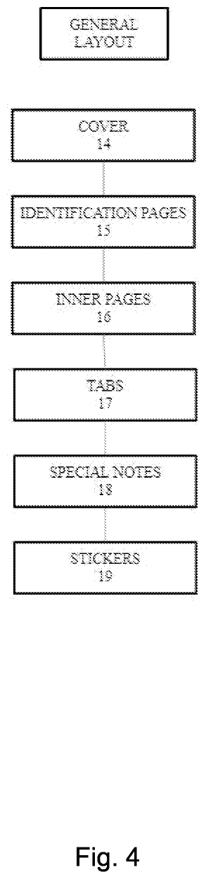

FIG. 5 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing various features interacting with the monthly layout.

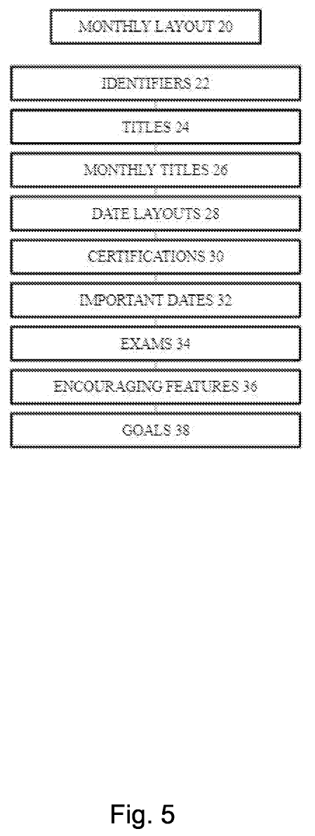

FIG. 6 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing various features interacting with the weekly views.

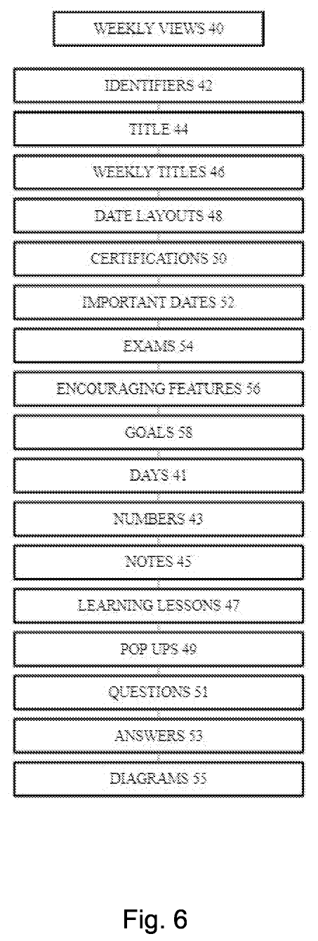

FIG. 7 is a diagram showing an organization system, organization process, learning system, memorization process, concept incorporation system, concept incorporation process, processes, and method of use; the view showing the system and a user; the view showing various components of the system a user interacts with; the view showing a planner as a representation of a hard copy or physical component; the view showing a graphical user interface and/or online component; the view showing gamification elements linked to the activity page features.

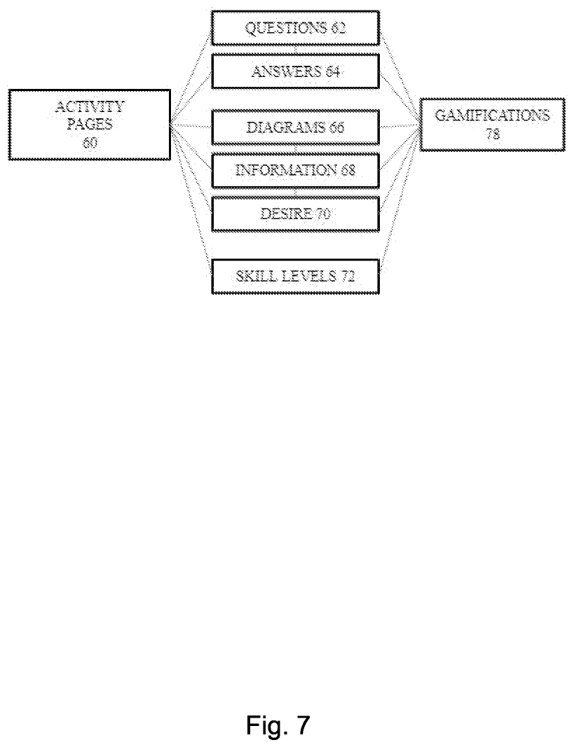

FIG. 8 is a diagram showing an organization system, organization process, learning system, memorization process, concept incorporation system, concept incorporation process, processes, and method of use; the view showing the core concepts and features associated with the core concepts.

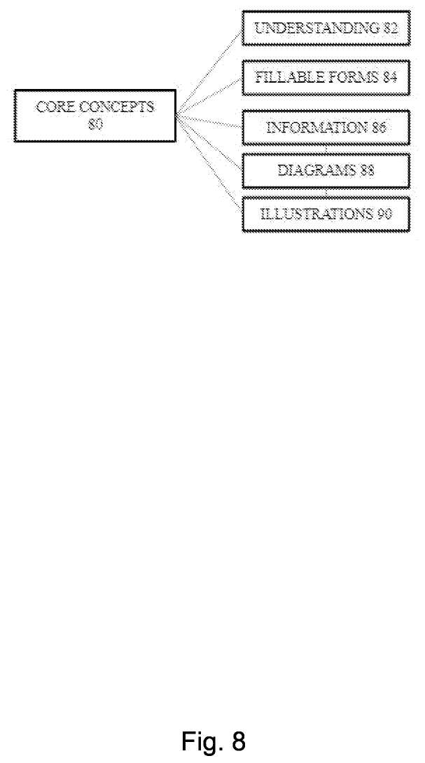

FIG. 9 is a diagram showing an organization system, organization process, learning system, memorization process, concept incorporation system, concept incorporation process, processes, and method of use; the view showing the budget; the view showing features of the budget; the view showing various secondary elements of budget and representation of a budget to a user.

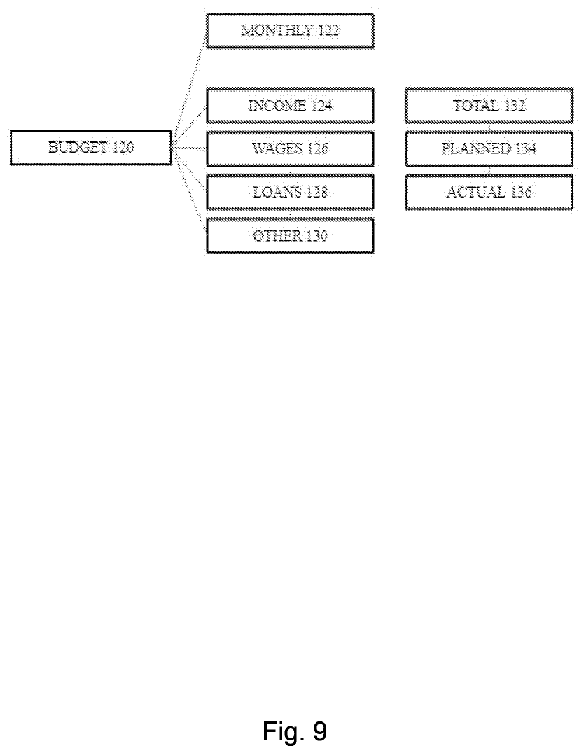

FIG. 10 is a diagram showing an organization system, organization process, learning system, memorization process, concept incorporation system, concept incorporation process, processes, and method of use; the view showing a life organization feature; the view showing various elements of the life organization feature and interactions of these elements.

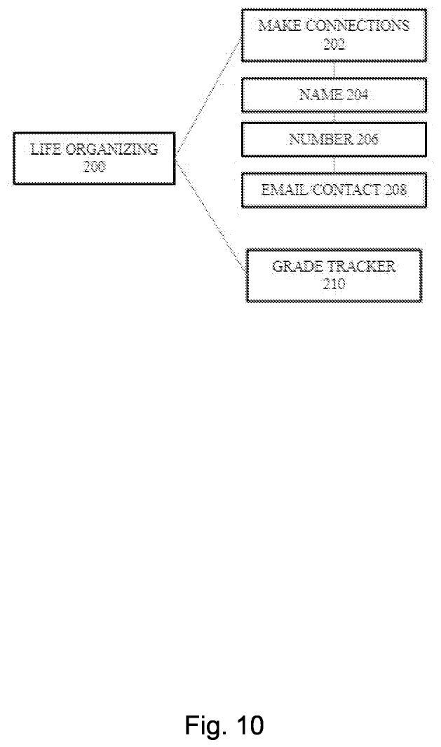

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Organization system, organization process, learning system, memorization process, concept incorporation system, concept incorporation process, (also known as “organization system”, or “learning system”, or “education system”, or “core concept system”, or “training system”, or “simulation system”, and “diagnostic system”, or simply “system”), process, and method of use is configured to provide an immersive learning and organization tool which aids a user in memorizing key concepts while also organizing and learning life planning skills.

In this way, the present disclosure provides an interactive learning environment that allows students to learn medical skills, especially nursing skills. More specifically, the disclosure provides a realistic learning environment for nursing school which focuses on key concepts as are needed for success in nursing school. More specifically, the present disclosure provides a virtual, interactive, immersive learning environment that aids in the complex learning of medical terminology, nursing tasks, and human health. Furthermore, the disclosure provides all of these tools and learning functionality in addition to providing life organization, including but not limited to, budgeting, daily planning, weekly planning, monthly planning, yearly planning, and the like. These medical diagnoses and planning are a complex part of a nurse's day life which requires extensive readily available human health knowledge and long hours while also balancing a budget and planning.

In one way, and in one aspect of the disclosure, an interactive technology is utilized. In the arrangement shown, as one example, the organization and learning system is a visualization system which includes both video and audio devices, which are interactive. In one arrangement, virtual reality is used. Virtual reality is often a term used to describe a holographic display type configured to display a virtual environment which appears to be three-dimensional to a user. This environment can often be interacted with by a user through sensors and other control instruments. The computing device deployed to create and help a user interact with the organization and learning system is often coupled to other systems and devices herein, such as a smart device, a smart phone, a tablet, and sometimes an audio device.

Embodiments of the present disclosure include an organization system, organization process, learning system, memorization process, concept incorporation system, concept incorporation process, and methods of use for learning core concepts related to nursing while also organizing personal life and balancing personal life with nursing school. The embodiments herein include questions and answers and a number of other unique tools for learning core concepts and learning and engaging with organization and planning skills.

The embodiments disclosed herein store information gathered and/or data in a comprehensive database containing a myriad of information about the historical data, environmental data, occupational data, personal assets, personal schedule, scheduling databases, and such as nursing input and similar tools for similar tasks to determine the needs of each student and/or nurse.

Furthermore, an organization system, organization process, learning system, memorization process, concept incorporation system, concept incorporation process, and methods of use, for the first time, allows a nurse and/or nursing student to simulate real world experiences.

System:

With reference to the figures, an organization system, organization process, learning system, memorization process, concept incorporation system, concept incorporation process, processes, and method of use is presented (hereafter known as “medical specialty planner”, “organization system”, or “learning system”, or “education system”, or “core concept system”, or “training system”, or “simulation system”, and “diagnostic system”, or simply “system”).

Organization system, organization process, learning system, memorization process, concept incorporation system, concept incorporation process, processes, and method of use 10 is formed of any suitable size, shape and design. In the arrangement shown, as one example, system 10, which may comprise remote servers, databases, application servers, application databases, application programming interfaces, product databases, mobile applications, simulators, and/or computers that fulfill the functions disclosed herein, also includes, in the embodiment depicted, a graphical user interface, a user, a simulator system, a computer system, a plurality of application server, and a cloud computing system, among other components.

Additionally, and in the arrangement shown, as one example, system 10 also includes a planner 12, a cover 14, a plurality of identification pages 15—including but not limited to phone number identification, address identification, email identification, facebook identifiers, instagram identifiers, among other identifying information—as well as inner pages 16, a plurality of tabs 17, thank you notices 18, stickers 19, a monthly layout 20, a weekly views feature 40, a plurality of activity pages 60, a plurality of core concepts 80, a habit tracker 100, a budget feature 120, a plurality of coloring pages 140, at least one quick reference guide 180, and a life organizing system 200, among other features, components, and functionality.

User: In the arrangement shown, as one example, system 10 includes a user 11. User 11 may be any user of system 10. In the arrangement shown, as one example, a user 11 is a medical professional. More specifically, and without limitation, in the arrangement shown as one example, user 11 is a nursing student in nursing school and/or a practicing nurse and/or a registered nurse and/or a nurse practitioner.

In the arrangements, processes, and methods described herein, a user 11, is a nursing student or nurse. This is for example purposes only and for ease of describing the disclosure, processes, and methods. A user 11 may also be, but is not limited to, any medical practitioner including nurses, physicians assistants, doctors, students, teachers, any combination of users and the like, another student whether a law student, and other advanced degree students. For example, herein, when referring to a user 11, a user 11 may be a group of students learning from a teacher in a traditional classroom like approach but within the virtual world. Furthermore, a user 11 may also include other areas of practice such as dentists or optometrists and professionals that make decisions. For these reasons a user 11 may be any person or group of people navigating or working within the system 10 and/or graphical user interface of the system 10, and or exercising the methods or processes herein.

Planner Platform:

In the arrangement shown, as one example, system 10 includes a planner 12 (also known as “planner platform”). Planner 12 is formed of any suitable size, shape, and design and is configured as the main immersive system in which a user interacts. In this way, the planner system provides a single interface for a user to go for organizing, planning future events, planning budgets, and the like. Said another way, the planner 12 provides a simple, visual way for a user to organize work and life.

Additionally, the planner 12 contains a number of other features and functionality for learning core concepts in nursing, for memorizing core concepts in nursing, for having access to quick reference guides, for planning yearly scheduling, for planning monthly scheduling, for planning yearly scheduling, for planning budgets, and the like. Each planner platform 12 is designed to be customized and/or tailored to a unique user or set of users such that goals for an individual can be achieved. Said another way, each planner platform provides for customization of goals and planning while also providing a fun and easy means for a user goal setting and goal achieving.

Cover:

In the arrangement shown, as one example, system 10 and/or planner platform 12 includes a cover 14. Cover 14 is formed of any suitable size, shape, and design and is configured to provide a fun, engaging introduction to a user wishing to use the system.

Additionally, and in an alternative embodiment, cover 14 may function as a landing page and/or may serve as a login page where a user can enter credentials to gain access to that user's customized system 10. In the arrangement shown, as one example, the cover 14 may include login credentials such as a username and password. Additionally, and in one embodiment, the cover page 14 may also include a logo and/or a customized picture or plurality of pictures. Additionally, the cover 14 may also include unique art designs and the like.

In the arrangement shown, as one example, a cover 14 can be customized by a user but is generally left as a cover 14. In this way, a user can decide what information may be displayed on a cover 14 and/or cover page 14. A user may desire to have upcoming events and/or critical upcoming events displayed on their cover 14. Additionally, a cover 14 may include a pop quiz question at the time of login for helping users remember core concepts. In this way, the pop quiz question may require an answer before a user can proceed. These and other features for a cover 14 are hereby contemplated for use.

Identification Pages:

In the arrangement shown, as one example, system 10 includes a plurality of identification pages 15. The plurality of identification pages 15 (also known as “identification cards”, or “contact pages”, or simply “contacts”) is formed of any suitable size, shape, and design and is configured to provide a unique place for a user to store information related to contacts one makes professionally, in the nursing field, in nursing school, and the like. In this way, a user can make contacts, store these contacts in unique locations, and recall unique groups. For example, a user may wish to create a group of contacts for a group project, or for a unique class, so the contact feature 15 and grouping feature 15 allows a user to do this.

In the arrangement shown, a contact 15 or identification page may include a phone identification number, an address, an email, a facebook page link, an instagram account link, among other identifiers.

Inner Pages:

In the arrangement shown, as one example, system 10 includes a plurality of inner pages 16. Inner pages 16 are formed of any suitable number, size, shape, and design and may be customized by a user. Inner pages 16 are configured as the main interaction pages that provide a plurality of features from weekly planning, to monthly planning, to yearly planning, to budget planning, to note taking, to core concept memorization tools and features, to quizzes, to question and answers, and the like. The inner pages 16 and the various functionality of the inner pages 16 are further discussed herein.

Plurality of Tabs:

In the arrangement shown, as one example, system 10 and/or inner pages 16 includes a plurality of tabs 17. Plurality of tabs 17 (or simply “tabs”) are formed of any suitable size, shape, and design and can be customized by a user. Plurality of tabs 17 are a means for a user to quickly jump from a page to another page in a way that makes accessing information easy and fun. The plurality of tabs 17 are further discussed herein.

In an alternative embodiment, the plurality of tabs 17 are equipped with machine learning such that a system highlights a tab which is needed next or regularly accessed within a predetermined and changing set of rules. In this way, the plurality of tabs 17 can be more easily used and accessible for a user. For example, if a user is engaging in question and answer, after the question tab is highlighted or amplified by a user, then the question tab is accessed, the system might highlight and/or amplify the questions tab. In this way, a user can move more swiftly and easily to access information and/or store information and/or data as is needed to make the most of system 10.

Monthly Layout:

In the arrangement shown, system 10, and more specifically inner pages 16 includes a monthly layout feature 20. Monthly layout feature 20 is formed of any suitable size, shape, and design and may be customized by a user. In the arrangement shown, as one example, monthly layout feature 20 is configured to provide a user with a monthly calendar-like interface. In this way, a user can quickly add, remove, modify, and/or review activities, goals, deadlines, important items over the duration of a month and in a monthly view with each day of the month labeled and each number labeled.

In the arrangement shown, as one example, a plurality of boxes are displayed which correspond to each day of the month. In this way, a user can quickly view information coming up that month and can quickly understand important dates and/or other important information. In the arrangement shown, as one example, a user can add tasks, budgeting items, deadlines, and the like to any calendar day. Furthermore, a user can highlight, strikethrough, and manipulate individual entries. These and other forms of highlighting and manipulating are hereby contemplated for use.

In the arrangement shown, as one example, monthly layout feature 20 includes, but is not limited to a plurality of identifiers 22, a title 24, a plurality of monthly titles 26, a date layout 28, a plurality of certifications 30, a plurality of important dates feature 32, an exams feature 34, an encouragement feature 36, and a goals feature 38, among other components, features, and functionality.

Weekly Views Feature:

In the arrangement shown, system 10, and more specifically inner pages 16 includes a weekly layout feature 40. Monthly layout feature 40 is formed of any suitable size, shape, and design and may be customized by a user. In the arrangement shown, as one example, weekly layout feature 40 is configured to provide a user with a weekly calendar like interface. In this way, a user can quickly add, remove, modify, and/or review activities, goals, deadlines, important items over the duration of a month and in a weekly view with each day of the week labeled and each number labeled.

In the arrangement shown, as one example, a plurality of boxes are displayed which correspond to each day of the week. In this way, a user can quickly view information coming up that week and can quickly understand important dates, fun dates, and/or other important information. In the arrangement shown, as one example, a user can add tasks, budgeting items, deadlines, and the like to any calendar day. Furthermore, a user can highlight, strikethrough, and manipulate individual entries. These and other forms of highlighting and manipulating are hereby contemplated for use.

In the arrangement shown, as one example, monthly layout feature 20 includes, but is not limited to a days feature 41, a plurality of identifiers 42, a numbers feature 43, a title 44, a notes feature 45, a plurality of weekly titles 46, a learning lessons feature 47, a date layout 48, a weekly pop up questions feature 49, a plurality of certifications 50, a questions feature 51, a plurality of important dates feature 52, an answers feature 53, an exams feature 54, a diagrams feature 55, an encouragement feature 56, and a goals feature 58, among other components, features, and functionality.

Daily Views Feature:

In the arrangement shown, system 10, and more specifically inner pages 16 may also include a daily layout feature. Daily layout feature is formed of any suitable size, shape, and design and may be customized by a user. In the arrangement shown, as one example, daily layout feature is configured to provide a user with a daily calendar like interface. In this way, a user can quickly add, remove, modify, and/or review activities, goals, deadlines, important items over the duration of a day and in a daily view with each day and time of events during that day labeled and each number labeled.

In the arrangement shown, as one example, a plurality of boxes are displayed which correspond to each day and time of the day. In this way, a user can quickly view information coming up that day and at what time the event occurs and can quickly understand important dates, times, deadlines for the day, fun dates, and/or other important information. In the arrangement shown, as one example, a user can add tasks, budgeting items, deadlines, and the like to any calendar day. Furthermore, a user can highlight, strikethrough, and manipulate individual entries. These and other forms of highlighting and manipulating are hereby contemplated for use.

In the arrangement shown, as one example, daily layout feature includes, but is not limited to a date and time feature, a plurality of identifiers, a numbers feature, a title, a notes feature, a plurality of day titles, a learning lessons feature, a date layout, a time layout, a daily pop up questions feature, a plurality of certifications, a questions feature, an answers feature, a plurality of important times feature, an exams feature, a diagrams feature, an encouragement feature, and a goals feature, among other components, features, and functionality.

Activity Pages:

In the arrangement shown, as one example, system 10 and more specifically inner pages 16 includes an activity pages feature 60. Activity pages feature 60 (also known as “activity feature”, or “learning feature”, or “engagement feature”) is formed of any suitable size, shape, and design and is configured to provide an interactive feature which a user engages in a stimulus and provides answers and gets feedback. In one arrangement, this feedback feature may be in the form of questions and answers. This includes, but is not limited to multiple choice questionnaires and like.

In the arrangement shown, as one example, the activity pages 60 includes various stimulus and responses that are not limited to questions 62 and answers 64. These other stimuli 61 may include filling in diagrams 66 with information 68, telling whether a vital sign is in a desired range, identifying certain abnormal activity within a patient, and the like. These activity pages 60 can also be customized by a user based on desire 70 and skill level 72. Furthermore, the activity pages 60 in an alternative embodiment are set with machine learning capabilities to adjust to different knowledge levels of a user.

Additionally, and in an alternative embodiment, activity pages, includes a live person for response and questions. This live person may be available through a video chat, a messaging feature, and the like. In the arrangement shown, as one example, the live person is an experienced nurse readily available to answer questions and provide guidance both in nursing as associated with key concepts, practice, and the like. Additionally, and in another embodiment, the live person may be a financial expert available to help with balancing budgets, managing funds, and the like. Additionally, and in another embodiment, the live person may be a coach and/or teacher so as to help with specific coursework and/or a larger goal of work life balance and providing pointers and the like.

In an alternative embodiment, activity pages 60 include a gamification element 78. Gamification element 78 is formed of any suitable size, shape, and design and is configured to provide psychological encouragement and engagement. In this way, the gamification elements 78 of system 10 encourage a user to keep using system 10 by providing awards, badges, and other stimuli. Additionally, gamification may provide lights and other encouraging and fun activities which entice a user and aid a user in gaining knowledge and having fun.

Core Concepts:

In the arrangement shown, as one example, system 10 includes a core concepts feature 80. Core concepts feature 80 is formed of any suitable size, shape, and design and is configured to aid a user in learning and memorizing core concepts 80 as the concepts relate to the particular field. In the arrangement shown, as one example core concepts 80 are concepts that are desired to be learned and/or memorized in nursing school. Some examples of core concepts 80 include but are not limited to, human concepts, environmental concepts, health concepts, nursing concepts and the like.

In the arrangement shown, as one example, core concepts 80 include, but are not limited to some of the following features, understanding 82, fillable forms 84, information 86, a plurality of diagrams 88, and a plurality of illustrations 90, among other concepts, learning features, components, and functionality.

Habit Tracker:

In the arrangement shown, as one example, system 10 also includes a habit tracker 100. Habit tracker 100 is specially designed to provide encouragement and tracking of habits such as uses, questions and answers, and other frequency data and tracking that may be encouraging information to a user. In an alternative embodiment, habit tracker 100 is also incorporated into a gamification element.

Budget System:

In the arrangement shown, as one example, system 10 includes a budget system and/or budget feature 120. Budget feature 120 is formed of any suitable size, shape, and design, and may be customized by a user. Budget feature 120 is configured to provide a simple tool such that a user can plan and track budget and provide constraints on budget.

In the arrangement shown, as one example, budget feature 120 includes a monthly budget planning feature 121, a weekly budget planning feature 122, a daily budget planning feature 123, an income 124, a wages feature 126, a loan feature 128, an other income feature 130, a calculator feature 131, a total budget calculation 132, a planned budget calculation 134, and an actual 136, among other features components and functionality. In an alternative embodiment, budget feature 120 is also incorporated into a gamification element.

Coloring Feature:

In the arrangement shown, as one example, system 10 includes a coloring feature 140. Coloring feature 140 (also known as “coloring pages”, or “coloring elements”) are formed of any suitable, size, shape, and design and are configured to provide a fun and easy interaction for a user such that a user can engage with core concepts and other activity pages in a creative and fun way. In this way, the learning of core concepts and/or other information is made more easily with a coloring feature. Also, in this way, a user can engage in a fun and relaxing activity, expressing creativity and the like. In this way, a user can learn and relax at the same time. In an alternative embodiment, coloring feature 140 is also incorporated into a gamification element.

Reference Guides:

In the arrangement shown, as one example, system 10 includes a plurality of reference guides 180. Reference guides 180 (also known as “quick reference guides”, or “quick guides”, or “reference guides feature”) is formed of any suitable size, shape, and design and may be customized by or to a user for a given field. Quick reference guides 180 are configured to provide reference guides that provide critical information for a given field. In nursing, these quick reference guides need to be easily accessible for the fast paced life of nursing which involves quick decisions that can have dramatic effects on human health. Quick reference guides 180 are configured to provide quick access to various information in an easily accessible manner such that a nurse can have needed information at their fingertips.

Life Organization System:

In the arrangement shown, as one example, system 10 also includes a grade tracking system 200 as part of the life organization system. Grade tracking system 200 is formed of any suitable size, shape, and design and is configured to provide an easy grade tracking and calculation system. In this way, the grades of any nursing course and/or course can be easily tracked. In an alternative embodiment, grade tracking feature 200 is also incorporated into a gamification element.

Graphical User Interface:

In the arrangement shown, as one example, system 10 includes a graphical user interface 13 (or “Interface”, “Simulator”, “Learning Interface”, or simply “Interface”). Graphical user interface 11 is formed of any suitable size, shape, and design and is configured as the primary interface for which a user 11 interacts dynamically with system 10. Graphical user interface is not limited to an electronic and/or touchscreen interaction but also includes various interactive features that can be performed on a computer screen, a portable computing device, and/or a handheld mobile device and/or through a physical planner in the real world.

In this way, and disclosed herein, the graphical user interface 11 is a uniquely designed space for educational purposes in the medical field and/or a uniquely designed space for planning and work life balance, via setting goals and the like. More specifically, and without limitation, the graphical user interface 11 is designed to educate students and medical practitioners in the art of nursing practice and throughout life. In this way, students or practitioners can learn how to create a work life balance while integrating a new field of learning and/or practice into their daily lives.

Computer System:

In the arrangement shown, as one example, system 10 includes a computer system 300. Computer system 300 (or “computing device”) is formed of any suitable size, shape, and design and configured to process and store data related to the system 10. Additionally, computer system 300 is configured to provide real-time calculations, processes, and updates to system 10 while providing storage and historical data in various databases.

In one arrangement, as is shown, system 10 includes a computing device connected with electronic network and/or database and/or server or cloud and includes a processor, memory, a microcontroller, a circuit board, a mobile computing device, a microprocessor, a receiver and/or transceiver, and an antenna, among other components. Computing devices may be formed of any computing device capable of displaying and manipulating data in the manners described herein. Computing devices may include for example a desktop computer, a laptop computer, a tablet, smart phone, or any other computing device or other interactive device.

Said another way, a computing device is configured to provide for the main off-board computing processing and implementation of computer handling of data from data gathering performed within the environment. The data processing may include, but is not limited to, artificial intelligence of sorting and organizing images gathered which may include stitching and object recognition. In the arrangement shown, as one example, a computing device may include both an onboard computer device and an off-board computer, among other computing components and/or features.

Computing device may be a single consolidated component, or alternatively, computing device may be formed of a plurality of interconnected components that may be co-located or located at different geographic locations. Computing devices may be cloud based or it may be hardware based. In addition, the connected components of a computing device including processor, memory, software and interactive user display, may be co-located with a computing device or located at different geographic locations. That is, a computing device may be made of any form of a device or system that individually or collectively performs the computing operations of the system 10.

Printed Circuit Board: In the arrangement shown, as one example, system 10 includes a printed circuit board (“PCB”). Printed circuit board is formed of any suitable size, shape and design and is configured to facilitate carrying and/or holding other components and/or parts necessary to carry out various computation and/or related functions of system 10. PCB, as one example, might be a surface mounted printed circuit board or a through-hole printed circuit board and/or another type of circuit board. Printed circuit board, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the printed circuit board.

In an alternative embodiment, system 10 may not include an onboard computer device, but instead houses only a receiver and/or transceiver for sending and/or receiving information which is both sensed and/or information which is sensed and/or captured by the image capturing devices of system 10. In this way, system 10 may be connected to a mobile computing device via a bluetooth connection, a direction connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an Internet connected device, a hard-wired device, or any other device capable of transmitting remote control signals.

Memory: In the arrangement shown, as an example, system 10 includes a memory. Memory may be formed of any suitable size, shape and design and is configured to facilitate selective storage and retrieval of data (including data) in association with computing device, processor, software and interactive user display. Memory may be a single component, such as a single chip or drive or other memory device, or alternatively memory may be formed of a plurality of memory or storage components that are connected to one another that may be co-located or located at different geographic locations.

In addition to the above identified features, options, controls, and components, computing system may also include a plurality of cables, a mobile computing device, an application, a case, a case charger, or charging cord, a rechargeable battery or rechargeable power source, a system dock, among other options, controls, and components.

Application Server:

In the arrangement shown, as one example, system 10 comprises remote servers, databases, and/or computers that fulfill the functions disclosed and described herein. In the embodiment depicted, system 10 includes, among other computing processing systems, an application server. Application server comprises one or more computer systems adapted to transmit and receive data regarding selected datasets related to various users and/or datasets related to multiple users. Application server is adapted to a query database with unique identification codes to retrieve a list of brand and/or product and/or license rules related to various users. Application server may transmit product data related to layers and rules with respect to a single user and/or multiple users and/or multiple users associated with the same account, including but not limited to, a group of students, teachers, and/or physicians. Application server is also adapted to query a patient database. This query includes receiving and sending patient identification codes and patient data. Additionally, the application server may communicate with a mobile application, which is adapted to present the patient information in a form conducive to being viewed on a mobile device and/or handheld device and or displayed in a virtual reality simulator along with other information for display in the simulator.

As one of ordinary skills in the art may understand, application server, patient database, and other databases mentioned herein may be implemented in one or more servers. Furthermore, each may be on multiple servers to increase system efficiency, especially when handling large data gathering, large amounts of information such as three-dimension modeling of patients, historical patient information, and/or following extended rules for medicine and/or user profiles and calculating live inputs and interactions of patient data and effects of various treatments. Additionally, multiple servers may have mirrored data to prevent data loss in case of disk failure and/or to decrease access and response times for database queries. In alternative embodiments, application server, and other database procedures may be carried out on computer-readable instructions and data stored on the users device and or in a cloud computing system. Additionally, system 10 includes and may be run on one or more application programming interfaces (“API”) which includes tools and resources enabling a user to operate the embodiments herein.

Cloud Computing System:

In the arrangement shown, as one example, system 10 includes a cloud computing system. Cloud computing system is formed of any suitable size, shape, and design and is configured to incorporate the functionality of system 10 into a cloud database and computing system such that users can access the system from any location around the world where an internet or cellular communication, or other communication, can be made.

In Operation/Method of Use:

As one example of a method of use organization system, organization process, learning system, memorization process, concept incorporation system, concept incorporation process, and processes is presented herein.

It will be appreciated by those skilled in the art that other various modifications could be made to the device without parting from the spirit and scope of this disclosure. All such modifications and changes fall within the scope of the claims and are intended to be covered thereby.

What is claimed:

1. An organization and learning system, comprising:
a user;
a planner platform;
the planner platform having a cover page;
the planner platform having a plurality of identification pages;
wherein the identification page includes a phone, an address, an email;
the planner platform having inner pages;
the planner platform having tabs;
a graphical user interface;
a monthly feature;
the monthly feature having a plurality of identifiers;
the monthly feature having a title;
the monthly feature having a plurality of monthly titles;
the monthly feature having a plurality of date layouts;
a weekly feature;
the weekly feature having a plurality of identifiers;
the weekly feature having a title;
the weekly feature having a plurality of weekly titles;
the weekly feature having a plurality of date layouts;
a plurality of activity pages;
the plurality of activity pages having learning content;
the plurality of activity pages having questions associated with the learning content;
the plurality of activity pages having answers associated with the questions of the learning content;
the plurality of activity pages having diagrams associated with the learning content;
the plurality of activity pages having information associated with the learning content;
the plurality of activity pages having a skill level associated with a skill level of the user based on a periodic testing feature;
a gamification element;
wherein the gamification element provides encouraging features which encourage the user to continue to learn through a reward system;
wherein the gamification element provides badges;
a plurality of core concepts;
the plurality of core concepts having an understanding metric;
the plurality of core concepts having a plurality of fillable forms;
a budget platform;
the budget platform having a monthly budget feature;
the budget platform having an income feature;
a quick reference guide;
the quick reference guide providing various references for a particular subject matter;
a life organization feature;
wherein the system is configured to provide gamified learning of complex subject matter;
wherein the system is configured to provide budgeting for the user of personal finances.

2. The system of claim 1, further comprising:
a second user;
wherein the second user acts as a tutor for the user.

3. The system of claim 1, further comprising:
the monthly feature having certifications;
the monthly feature having a plurality of important dates;
the monthly feature having a plurality of exam dates;
the monthly feature having encouraging features;
the monthly feature having a plurality of goals.

4. The system of claim 1, further comprising:
a habit tracker.

5. The system of claim 1, further comprising:
the plurality of core concepts having information related to each of the plurality of core concepts;
the plurality of core concepts having a set of diagrams related to each of the plurality of core concepts;
wherein the user of the planner platform learns and organizes information related to a medical specialty;
wherein the user of the planner platform organizes information related to monthly planning;
wherein the user of the planner platform organizes information related to weekly planning.

6. The system of claim 1, further comprising:
a daily feature.

7. The system of claim 1, further comprising:
the budget platform having a wages feature;
the budget platform having a loans feature;
the budget platform having an other income feature;
the budget platform having an other debit feature;
the budget platform having a planned feature;
the budget platform having an actual feature.

8. The system of claim 1, further comprising:
a coloring fill feature;
wherein the user can fill shapes with various colors.

9. The system of claim 1, further comprising:
wherein the life organization feature includes a make connections feature;
wherein the make connections feature is configured to connect in communication a plurality of users which are learning and organizing in similar fields.

10. The system of claim 1, further comprising:
wherein the understanding metric displays to the user what comprehension the user has of a particular subject matter;
wherein the understanding metric is determined by a predetermined set of rules based on a performance of the user;
wherein the performance of the user includes correct responses to questions;
wherein the performance of the user includes incorrect responses to questions;
wherein the performance of the user includes understanding of diagrams.

11. The system of claim 1, further comprising:
wherein the diagrams are associated with a plurality of questions;
wherein the diagrams are associated with a plurality of answers.

12. The system of claim 1, further comprising:
the weekly feature having certifications;
the weekly feature having a plurality of important dates;
the weekly feature having a plurality of exam dates;
the weekly feature having encouraging features;
the weekly feature having a plurality of goals;
the weekly feature showing days of the week;
the weekly feature showing numbers associated with dates of the days of the week;
the weekly feature having a notes feature;
the weekly feature having a plurality of learning lessons;
the weekly feature having a plurality of pop-up questions;
the weekly feature having a plurality of questions;
the weekly feature having a plurality of answers;
wherein the plurality of questions are associated with a plurality of answers.

13. The system of claim 1, further comprising:
the weekly feature having certifications;
the weekly feature having a plurality of important dates;
the weekly feature having a plurality of exam dates;
the weekly feature having encouraging features;
the weekly feature having a plurality of goals;
the weekly feature showing days of the week;
the weekly feature showing numbers associated with dates of the days of the week;
the weekly feature having a notes feature;
the weekly feature having a plurality of learning lessons;
the weekly feature having a plurality of pop-up questions;
the weekly feature having a plurality of questions;
the weekly feature having a plurality of answers;
wherein the plurality of questions are associated with a plurality of answers;
the weekly feature having a plurality of diagrams;
wherein the diagrams are presented to the user;
wherein the diagrams provide learning and knowledge for the user.

14. The system of claim 1, further comprising:
the planner platform having thank you notices;
the planner platform having stickers.

15. An organization learning system and process, comprising
a user;
a planner platform;
the planner platform having a cover page;
the planner platform having a plurality of identification pages;
wherein the identification page includes a phone, an address, an email;
the planner platform having inner pages;
the planner platform having tabs;
a graphical user interface;
a monthly feature;
the monthly feature having a plurality of identifiers;
the monthly feature having a title;
the monthly feature having a plurality of monthly titles;
the monthly feature having a plurality of date layouts;
a weekly feature;
the weekly feature having a plurality of identifiers;
the weekly feature having a title;
the weekly feature having a plurality of weekly titles;
the weekly feature having a plurality of date layouts;
a plurality of activity pages;
the plurality of activity pages having learning content;
the plurality of activity pages having questions associated with the learning content;
the plurality of activity pages having answers associated with the questions of the learning content;
the plurality of activity pages having diagrams associated with the learning content;
the plurality of activity pages having information associated with the learning content;
the plurality of activity pages having a skill level associated with a skill level of the user based on a periodic testing feature;
a gamification element;
wherein the gamification element provides encouraging features which encourage the user to continue to learn through a reward system;
wherein the gamification element provides badges;
a plurality of core concepts;
the plurality of core concepts having an understanding metric;
the plurality of core concepts having a plurality of fillable forms;
a budget platform;
the budget platform having a monthly budget feature;
the budget platform having an income feature;
a quick reference guide;
the quick reference guide providing various references for a particular subject matter;
a life organization feature;
wherein the system is configured to provide gamified learning of complex subject matter;
wherein the system is configured to provide budgeting for the user of personal finances;
wherein the user interacts with the graphical user interface to learn lessons related to complex subject matter;
wherein the user interacts with the graphical user interface to answer questions related to complex subject matter;

16. The system of claim 15, further comprising:
wherein the user interacts with the graphical user interface to answer questions related to diagrams related to complex subject matter.

17. The system of claim 15, further comprising:
wherein the user interacts with the graphical user interface to plan the upcoming monthly schedule of the user;
wherein the user interacts with the graphical user interface to plan the upcoming weekly schedule of the user.

18. The system of claim 15, further comprising:
wherein the user interacts with the graphical user interface to plan the monthly budget of the user;
wherein the user interacts with the graphical user interface to plan the weekly budget of the user.

19. The system of claim 15, further comprising:
wherein the user interacts with the graphical user interface to connect with a plurality of users studying similar subject matter.

20. A method of organizing and learning complex data, comprising:
providing a planner platform; the planner platform having a cover, a monthly layout, a weekly layout, a habit tracker, and a life organizer;
filling in information related to scheduling;
reviewing complex subject matter provided;
answering questions provided;
receiving tracking information from a habit tracker;
receiving encouragement from a gamification element;
utilizing quick reference guides to look up information in timed circumstances;
tracking budget information.
